(19) United States
(12) Patent Application Publication
(10) Pub. No.: US 2003/0182199 A1
(43) Pub. Date: Sep. 25, 2003

(54) Pollution-free confirmation and marketing system using internet of the moving picture

(76) Inventor: Kim Kwang-II, Gwangju (KR)

Correspondence Address: POWELL, GOLDSTEIN, FRAZER & MURPHY LLP, P.O. BOX 97223, WASHINGTON, DC, 20090-7223, US

(21) Appl. No.: 10/200,766

(22) Filed: Jul. 22, 2002

(30) Foreign Application Priority Data
Mar. 19, 2002 (KR) 10-2002-0014759

(51) Int. Cl. G06F 17/60

(52) U.S. Cl. 705/26

(57) ABSTRACT

Disclosed is a pollution-free food confirmation and sales system using a moving picture on the Internet, comprising: a plurality of web cameras installed in a foods producing area; a web server adapted receive pictures of foods photographed by the plurality of web cameras; a database connected to the web server and adapted to store various picture information associated with the foods therein and providing it to users; an Internet network adapted to connect the web server and the users; and a plurality of user personal computers (PCs) having an Internet communication means installed therein and connected to the web server through the Internet network so that the users access the web server, whereby the pollution-free food confirmation and sales system is implemented by using a method of confirming and selling pollution-free food, comprising the steps of: accessing a web server through the Internet network; selecting the type of foods; selecting a foods producing area corresponding to the selected type of foods; displaying information about the corresponding foods and the foods producing and processing stages according to the selected foods producing area by using a moving picture menu; showing a specific moving picture for the corresponding foods selected by a user; selling the corresponding foods of the selected foods producing area to the user when the user requests a purchase of the corresponding foods.

### BACKGROUND OF THE INVENTION

1. Field of the Invention

The present invention relates to a pollution-free food confirmation and sales system using a moving picture on the Internet, and more particularly, to an Internet-based sales system which enables all the processes of production including a cultivation, a processing, etc., of various foods to be live-broadcasted to a consumer on a moving picture frame in real time using a web camera through the Internet to allow the consumer to identify whether or not the foods displayed on the moving picture frame are pollution-free ones and to purchase them with reliability.

2. Background of the Related Art

In general, a product sales system using the Internet is configured in such a fashion that when a buyer accesses an Internet shopping mall to search a product which the buyer desires to purchase among products displayed on the shopping mall, the appearance and the price of the searched corresponding product are displayed on a display screen, so that when the buyer clicks on this product or orders it from the shopping mall by using a telephone or the like, a product sale company prepares a product ordered to deliver it to the buyer.

Related techniques includes, for example, Korean Patent Application No. 10-2000-0035825 entitled “GOODS DISPLAYING METHOD AND SALES METHOD USING A MOVING PICTURE ON THE INTERNET”, Korean Patent Application No. 10-2000-0022701 entitled “PRODUCT SALES SYSTEM AND METHOD USING UNING THE INTERNET”, and Korean Patent Application No. 10-2001-0052336 entitled “PUBLICITY AND SALES SYSTEM OF ITEMS USING INTERNET REAL-TIME MOVING PICTURE”, which are known.

However, currently, when a consumer desires to purchase foods, he or she determines whether to buy or not to purchase them depending on actual foods exhibited in a grocery store, information or publicity contents about foods mentioned on a related Internet web site. This type of purchase behavior is based on a seller-oriented unilateral information circulation scheme in which a consumer only utilizes final information suggested by a food company.

In the meantime, a variety of foreign-made foods are recently imported, and even many foods that are produced and circulated in the country are polluted by various heavy metals. Under this serious domestic food circulation situation, the improvement of current dietary life styles of people brings about a user's strong desire of distinguishing pollution-free foods from diverse polluted foods. Nonetheless, there has been a problem in that since a consumer is discontented with an one-way purchase pattern which does not permit the identification of whether foods of interest is free from pollution while cannot finding a method of concretely confirming the non-pollution nature of foods, he or she could not help living a conventional dietary life as it is.

### SUMMARY OF THE INVENTION

Accordingly, the present invention is directed to a pollution-free food confirmation and sales system and using a moving picture on the Internet that substantially obviates one or more problems due to limitations and disadvantages of the related art.

An object of the present invention is to provide a pollution-free food confirmation and sales system using a moving picture on the Internet, which enables a buyer to view the producing and processing processes of foods ranging from an initial step to a final step through a moving picture frame, thereby allowing the buyer to feel confidence and reliability for a non-pollution nature of foods to be led to a purchase step.

Another object of the present invention is to provide a pollution-free food confirmation and sales system using a moving picture on the Internet, which extracts key frames, in a certain time period unit or a specific work content unit, from a moving picture frame created by a web camera to store them in a database, displays a number of key frames as consecutive scenes like a panorama in a short time through a web page, thereby allowing a buyer to, in a short while, observe the cultivation and processing stage of foods progressed for a few ten days, and giving the buyer confidence and reliability for a non-pollution nature of foods to lead him or her to a purchase step.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve this objects and other advantages and in accordance with the purpose of the invention, as embodied and broadly described herein, there is provided a pollution-free food confirmation and sales system using a moving picture on the Internet, comprising: a plurality of web cameras installed in a foods producing area; a web server adapted receive pictures of foods photographed by the plurality of web cameras; a database connected to the web server and adapted to store various picture information associated with the foods therein and providing it to users; an Internet network adapted to connect the web server and the users; and a plurality of user personal computers (PCs) having an Internet communication means installed therein and connected to the web server through the Internet network so that the users access the web server, whereby the pollution-free food confirmation and sales system is implemented by using a method of confirming and selling pollution-free food, comprising the steps of: accessing a web server through the Internet network; selecting the type of foods; selecting a foods producing area corresponding to the selected type of foods; displaying information about the corresponding foods and the foods producing and processing stages according to the selected foods producing area by using a moving picture menu; showing a specific moving picture for the corresponding foods selected by a user; selling the corresponding foods of the selected foods producing area to the user when the user requests a purchase of the corresponding foods.

The moving picture menu includes a real-time viewing by a farming spot fixed camera in which a user views the food producing and processing stages, in real time, through the fixed camera installed in a food producing area and processing spot, a real-time viewing by a moving camera for work in which a worker has a moving camera attached to his or her body to, in real time, show the current work contents to consumers, and a package viewing of the past work contents in which key frames and thumb nails are extracted, in a certain time period unit or a specific work content unit, from the past moving picture frames of the fixed camera and the moving camera so that they are displayed in consecutive scenes.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram illustrating the entire construction of a pollution-free food confirmation and sales system using a moving picture on the Internet according to a preferred embodiment of the present invention;

FIG. 2 is a flowchart illustrating the process routine for explaining the operation of a food purchase and sale transaction in the system of FIG. 1;

FIG. 3 is a block diagram illustrating the operation of an exemplary embodiment for the food purchase and sale transaction in the flowchart of FIG. 2;

FIGS. 4(a) and 4(b) are views illustrating a method of extracting key (representative) frames and thumb nails from a moving picture frame photographed by a web camera; and

FIG. 5 is a flowchart illustrating a method of creating a screen consecutively displaying the key frames and thumb nails extracted from the moving pictures frame.

### DETAILED DESCRIPTION OF THE PREFERRED EMBODIMENTS

Reference will now be made in detail to the preferred embodiments of the present invention, examples of which are illustrated in the accompanying drawings.

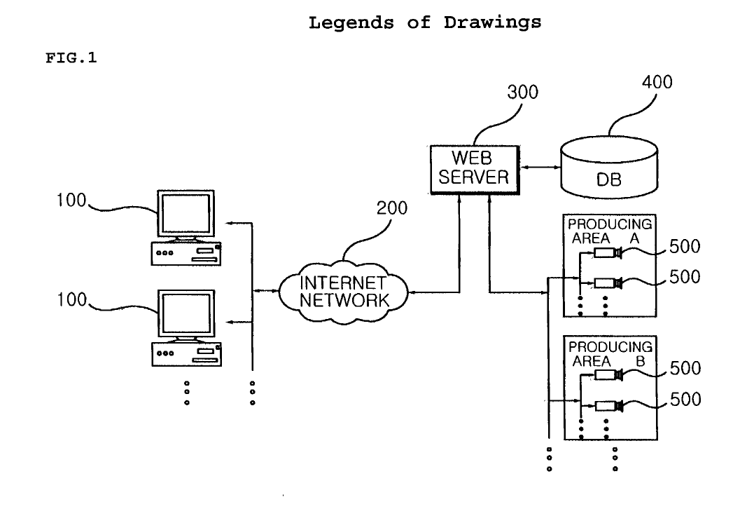

FIG. 1 is a schematic block diagram illustrating the entire construction of a pollution-free food confirmation and sales system using a moving picture on the Internet according to a preferred embodiment of the present invention.

Referring to FIG. 1, there is shown the pollution-free food confirmation and sales system of the present invention including a plurality of web cameras 500 installed in foods producing areas, a web server 300 for receiving pictures of foods photographed by the web cameras, a database 400 connected to the web server 300 for storing various picture information associated with the foods therein and providing it to users, an Internet network 200 for connecting the users to the web server 300, and a plurality of personal computers (PCs) 100 of the users having an Internet communication means installed therein and connected to the web server 300 through the Internet network 200 so that the users access the web server 300. The web server 300 is connected to the database 400.

The database 400 stores various information associated with foods therein. At this point, the information is classified by foods menu item. Also, the database 400 includes a database for storing inverted index file information containing a combination of key frames and thumbnails extracted from a moving picture frame, and the time period for which each frame is drawn.

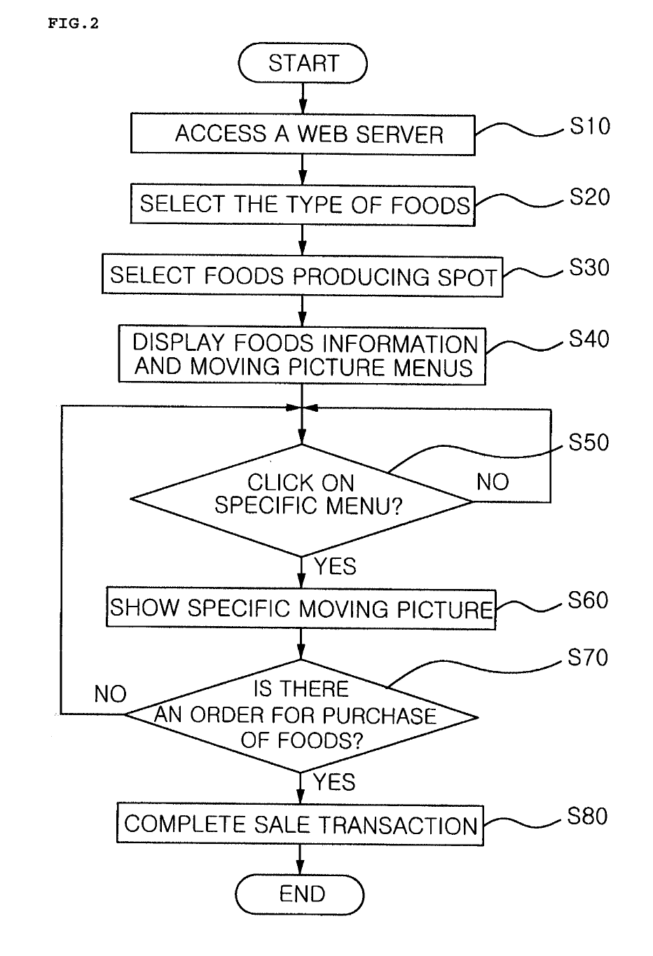

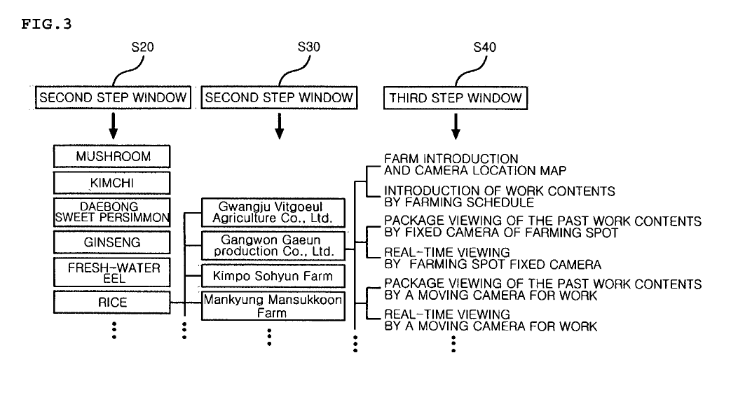

Now, an explanation on the operation of the pollution-free food confirmation and sales system using moving picture on the Internet of the present invention will be in detail given hereinafter with reference to FIGS. 2 and 3.

FIG. 2 is a flowchart illustrating the process routine for explaining the operation of a food purchase and sale transaction in the system of FIG. 1, and FIG. 3 is a block diagram illustrating the operation of an exemplary embodiment for the food purchase and sale transaction in the flowchart of FIG. 2.

Referring to FIG. 2, first, at step S10, a user PC 100 accesses a web server 300 through the Internet network 200.

At subsequent step S20, the web server 300 accesses the data stored in the database 400 and displays various foods menu items classified by the type of foods on a corresponding web page through a web browser of the user PC 100. For example, the foods menu items include mushroom, kimchi, Daebong sweet persimmon, ginseng, fresh-water eel, rice, etc.

At step S30, when a user selects specific foods, i.e., agricultural or fishery products from a foods menu displayed on a display screen of his or her PC 100, the web server accesses data stored in the database 400 and displays a list of the farming spots where the specific foods selected by the user are produced or processed on a corresponding web page through a web browser installed in the user PC 100. For example, as shown in FIG. 3, when the user selects “rice” in the food menu, a list of the rice producing and processing spot menu items such as Gangwon Gaeun production Co., Ltd., Gwangju Vitgoeul Agriculture Co., Ltd., Kimpo Sohyun Farm, Mankyung Mansukkoon Farm, etc., is displayed on the web browser.

At the next step S40, when the user selects a specific one among the displayed foods producing and processing spot menu items, the web server 300 accesses data stored in the database 400 and displays moving picture menus for showing detailed information about the foods produced in the selected specific foods producing and processing spot, a entire bird's eye view showing the producing area of the selected foods, a location map of a web camera, a description of work contents and the producing and processing stage of the foods on a corresponding web page through the web browser of the user PC 100.

Then, at step 50, when the user selects a specific one among the displayed moving picture menus, the web server 300 accesses the data stored in the database 400 to display a moving picture corresponding to the moving picture menu selected by the user on a corresponding web page through the web browser of the user PC 100.

At subsequent steps S70 and S80, when the user requests a purchase of the selected products by making an order for it, a sales transaction is carried out. At this time, a typical goods sale method through the Internet is used as the sales transaction method.

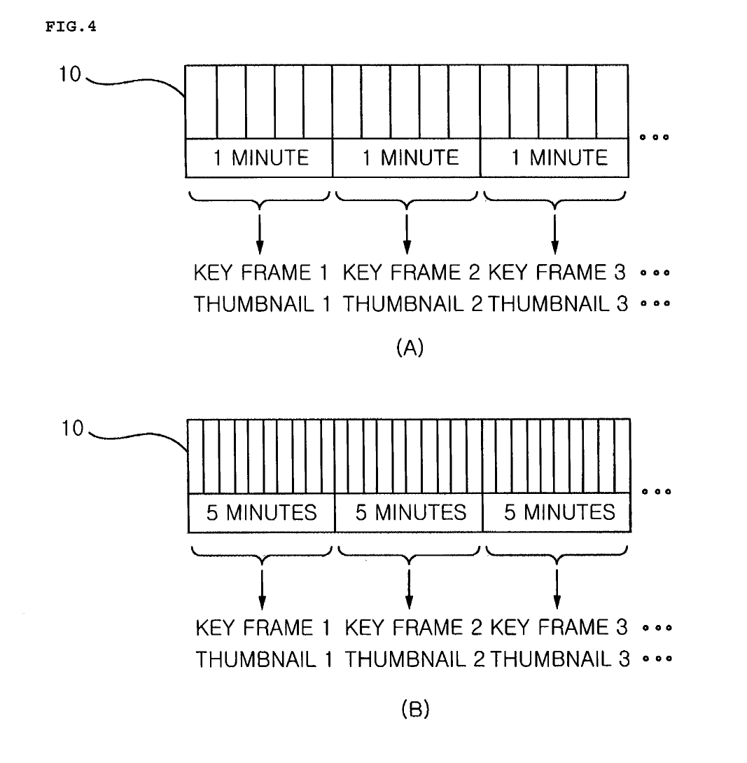

Next, an explanation on a method of extracting key frames and thumb nails from a moving picture frame will be in detail given hereinafter with reference to FIGS. 4(a) and 4(b).

FIGS. 4(a) and 4(b) are views illustrating a method of extracting key (representative) frames and thumb nails from moving picture frames photographed by a web camera.

Referring to FIG. 4(a), the key frames and thumb nails are extracted, in a certain time period unit of 1 minute, 5 minutes, 10 minutes, 30 minutes, etc., or a specific work content unit, from the moving picture frame 10.

Each frame extracted for the purpose of user's viewing of the moving picture creates inverted index file containing a combination of key frames and thumbnails extracted from a moving picture frame, and the time period unit for which a key frame is displayed so that a database is built. At this time, a start frame of a corresponding moving picture frame is stored in each index.

When a user selects a thumb nail or key frame, the web server 300 provides moving picture frames subsequent to the selected frame. Then, the user selects a specific thumb nail or key frame to monitors the foods producing and processing stage performed in a specific time zone and to confirm non-pollution nature of the monitored corresponding foods.

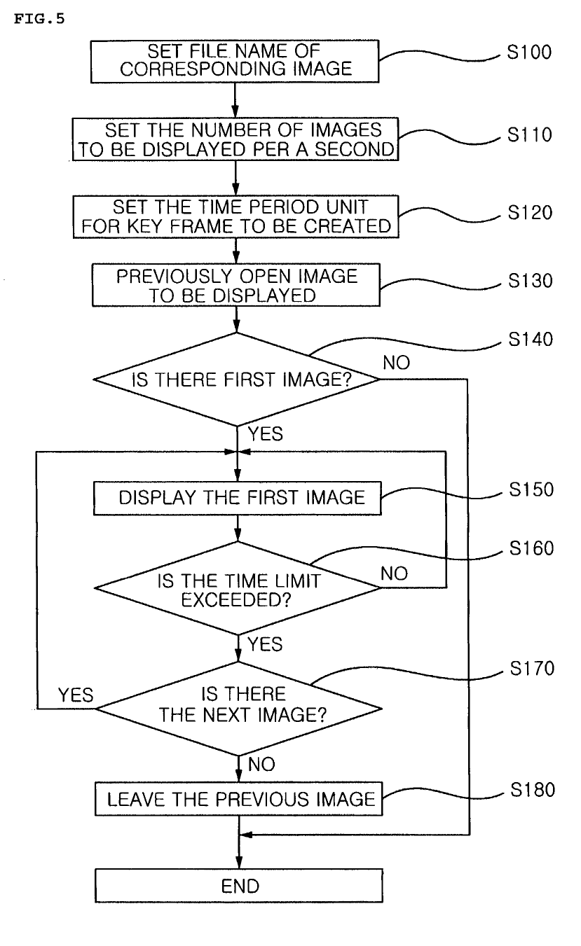

In the meantime, a method of consecutively displaying key frames and thumb nails extracted from a moving picture frame will be in detail described hereinafter with reference to FIG. 5.

FIG. 5 is a flowchart illustrating a process for consecutively displaying the key frames and thumb nails extracted from the moving pictures frame.

Referring to FIG. 5, first, when a user selects a key frame, a file name of a corresponding image is set (S100).

Next, the number of images to be displayed per a second is set (S110), and a time period unit for which a key frame is created is set (S120).

Subsequently, an image to be displayed is previously opened (S130), and the program proceeds to step S140 at which the web server 300 determines whether or not a first image exists. If it is determined at step 140 that the first image exists, the program proceeds to step S150 where the web server 300 displays the first image.

Then, the program proceeds to step S160 where the web server 300 determines whether or not the time period for which an image is displayed elapses according to the establishment of the number of images to be displayed per a second. If it is determined at step S160 that the time period does not elapse, the program returns to step S150 where the web server 300 displays the remaining images continuously. On the other hand, if it is determined at step S160 that the time period elapses, the program proceeds to step S170 where the web server 300 determines whether or not another image exists.

If it is determined at step S170 that another image exists, the program returns to step S150 where the web server 300 displays the other image. If, on the other hand, it is determined at step S170 that another image does not exist, the program proceeds to step S180 where the web server 300 leaves the previous image. Then, the process routine is concluded.

For example, when a user sets the number of images or key frames to be displayed per a second to “10” and the time period for which an image or key frame is displayed to “1 minute”, respectively, the total number of key frames to be created per a day is 1,440 (24×60). In this case, since 10 images per a second is displayed, the time taken for a user to view 1,440 key frames is 144 seconds, i.e., 2.4 minutes. Therefore, the user can identify the contents of his or her work that he or she did a day within 2.4 minutes through a display screen of his or her PC and determines whether or not the displayed foods are pollution-free ones.

As described above, according to a pollution-free food confirmation and sales system using a moving picture on the Internet of the present invention, a buyer can view the producing and processing processes of foods ranging from an initial step to a final step through a moving picture frame, thereby allowing the buyer to feel confidence and reliability for a non-pollution nature of foods to be led to a purchase step.

In addition, key frames are extracted, in a certain time period unit or a specific work content unit, from a moving picture frame created by a web camera to store them in a database, and a number of key frames are displayed as consecutive scenes like a panorama in a short time through a web page, thereby allowing a buyer to, in a short while, observe the cultivation and processing stage of foods progressed for a few ten days, and giving the buyer confidence and reliability for a non-pollution nature of foods to lead him or her to a purchase step.

Moreover, a consumer is easily connected with domestic food enterprises through the Internet, so that a new food market can be opened up based on reliability for non-pollution foods produced in the country and domestic agricultural and fishery food industry can be protected and fostered. Also, a consumer lively monitors a food producing spot through the Internet so that safety consumption culture can be invented which allows him or her to confirm pollution-free nature of foods and to eat them without anxiety. Furthermore, a new food production culture can be created in which the production of excellent natural foods makes the formation of a new customer possible, thereby resulting in the inducement of a public concern to recognition of pollution-free natural foods and secured superiority of domestic foods.

The forgoing embodiments are merely exemplary and are not to be construed as limiting the present invention. The description of the present invention is intended to be illustrative, and not to limit the scope of the claims. Many alternatives, modifications, and variations will be apparent to those skilled in the art.

What is claimed is:

1. A pollution-free food confirmation and sales system using a moving picture on the Internet, comprising:
a plurality of web cameras installed in a foods producing area;
a web server adapted receive pictures of foods photographed by the plurality of web cameras;
a database connected to the web server and adapted to store various picture information associated with the foods therein and providing it to users;
an Internet network adapted to connect the web server and the users; and
a plurality of user personal computers (PCs) having an Internet communication means installed therein and connected to the web server through the Internet network so that the users access the web server,
whereby the pollution-free food confirmation and sales system is implemented by using a method of confirming and selling pollution-free food, comprising the steps of: accessing a web server through the Internet network; selecting the type of foods; selecting a foods producing area corresponding to the selected type of foods; displaying information about the corresponding foods and the foods producing and processing stages according to the selected foods producing area by using a moving picture menu; showing a specific moving picture for the corresponding foods selected by a user; selling the corresponding foods of the selected foods producing area to the user when the user requests a purchase of the corresponding foods.

2. The pollution-free food confirmation and sales system according to claim 1, wherein the step of showing a specific moving picture further comprises the steps of: extracting key frames and thumb nails, in a certain time period unit or a specific work content unit, from a moving picture frame; allowing each frame extracted to create an inverted index file containing a combination of the extracted key frames and thumbnails extracted and the time period unit for which a key frame is displayed to build the database; consecutively displaying the extracted key frames and thumb nails on a corresponding web page through a web browser installed in the user PC.

3. The pollution-free food confirmation and sales system according to claim 2, wherein the step of consecutively displaying the extracted key frames and thumb nails further comprises the steps of: setting a file name of a corresponding image; setting the number of images to be displayed per a second; setting the time period unit for which a key frame is created; previously opening an image to be displayed; determining whether or not a first image exists; displaying the first image if it is determined that the first image exists; determining whether or not the time period for which an image is displayed elapses; determining whether or not another image exists if it is determined that the time period elapses; and leaving the previous image if it is determined that another image does not exist.
